(19) United States
(12) Patent Application Publication
(10) Pub. No.: US 2026/0097887 A1
(43) Pub. Date: Apr. 9, 2026

(54) BAG WITH SECURITY CLEARANCE PANEL

(71) Applicant: NIKE, Inc., Beaverton, OR (US)

(72) Inventor: George S. KIM, Wilsonville, OR (US)

(73) Assignee: NIKE, Inc., Beaverton, OR (US)

(21) Appl. No.: 18/816,519

(22) Filed: Aug. 27, 2024

(51) Int. Cl. B65D 33/04; H04W 4/80

(52) U.S. Cl. CPC B65D 33/04; H04W 4/80; A45C 2200/05; A45C 2200/10

(57) ABSTRACT

A bag, including an exterior surface and a storage compartment defining an interior volume. The at least a portion of the exterior surface is configured to transition between a first configuration and a second configuration in response to the bag receiving a signal.

### TECHNICAL FIELD

The present invention relates in general to portable storage bags, and more particularly, to bags with an exterior surface configured to transition from opaque to transparent.

### BACKGROUND

This section provides background information related to the present disclosure which is not necessarily prior art.

Various styles of portable bags are available. A bag may be worn by or secured to a user while the user is standing or in motion. A user selecting a portable bag may wish to have the ability to secure the contents of the bag from outside view. At times, a user may be required to show the contents of the bag for security purposes. It may be inconvenient for a user to open the bag and shuffle through the contents of the bag unnecessarily.

### SUMMARY OF THE DISCLOSURE

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary portable bag, according to one or more embodiments.

FIGS. 2A and 2B depict exemplary portable bags, according to one or more embodiments.

FIGS. 3A and 3B depict exemplary portable bags, according to one or more embodiments.

FIGS. 4A and 4B depict further exemplary portable bags, according to one or more embodiments.

FIG. 5 depicts an exemplary system for use with a portable bag, according to one or more embodiments.

FIG. 6 depicts an exemplary circuit for use with a portable bag, according to one or more embodiments.

FIG. 7 depicts an exemplary circuit for use with a portable bag, according to one or more embodiments.

FIG. 8 depicts an exemplary flow diagram, according to one or more embodiments.

### DETAILED DESCRIPTION OF EMBODIMENTS

The present disclosure overcome these challenges and other known disadvantages with existing storage bags by providing a bag with one or more exterior surfaces that may start opaque but transition to become transparent by way of a mobile device. The transparent surface may allow for a user to see into the bag (e.g., security purposes). The bag may then transition back to opaque after a period of time, hiding the contents of the bag from view of others.

Example embodiments will now be described more fully with reference to the accompanying drawings. Example embodiments are provided so that this disclosure will be thorough, and will fully convey the scope of those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. When an element or layer includes the directional and/or spatial term (e.g., top, bottom, medial, lateral, etc.), the directional and/or spatial term is used relative to when the athletic equipment bag is upright on a flat, level surface. The device may be otherwise oriented (rotated 90 degrees or at other orientations) and the spatially relative descriptors used herein interpreted accordingly.

In the discussion that follows, terms “about,” “approximately,” “substantially,” and the like, when used in describing a numerical value, denote a variation of +/−10% of that value, unless specified otherwise.

Although the description is in reference to a storage bag, it should be appreciated that such reference is merely exemplary. Bags include different types of portable storage apparatuses, such as, but not limited to, purses, backpacks, satchels, carriers, wait bags, belt bags, fanny packs, and the like. The technology disclosed herein may equally be used to create various types of bags and/or containers. To alleviate confusion and to provide a more readable disclosure, embodiments simply reference bags. To that end and to provide a robust disclosure, different components or portions of bags are discussed herein, including zippers, panels, and compartments.

Aspects hereof provide a bag that includes a main storage compartment that is accessible by opening one or more panels. One or more of the panels are releasably fastened to adjacent panels by way of a closure system, such as a zipper or other releasable fastener (e.g., one or more hook-and-loop strips, snaps, buttons, hooks, magnets, and the like). The bag might also include one or more accessory storage compartments constructed into the one or more panels or into a back panel of the bag.

The main storage compartment generally includes a storage space that may be larger than the accessory storage compartments, and might include one or more additional storage pockets accessible from inside or outside the storage space. The accessory storage compartments are generally separated from the storage space of the main storage compartment, and might be used to stow various items, such as one or more athletic balls, footwear, towels, uniforms, sports drinks, sports supplements, and the like. The terms “storage” and “stowage” might be used interchangeably in this description, as well as the terms “storage area,” “compartment,” and “storage space.” In addition, “accessory storage compartments” may also be referred to herein as “accessory compartments,” “accessory pockets,” “storage pockets,” or just “pockets”.

In a further aspect, the bag may be wearable as a clutch or wristlet. For instance, the bag may include up to one strap that can be carried or worn on the wrist of a user. In one aspect, the clutch or wristlet may be configured such that items stored in the main storage compartment are accessible by opening the closure system (e.g., releasable fasteners) securing any one or more of the panels to one another. Access may be allowed into the storage compartment from the top, bottom, left, or right side of the clutch or wristlet, or any combination thereof. Items stored within the accessory storage compartments are also accessible by opening any one or more of the fasteners or panels.

In a further aspect, the bag may be wearable as a backpack. For instance, the bag might include one or more straps that can be worn on one or both shoulders of a user. A normal manner of wear for the bag, when configured as a backpack, is for the user to place one or both arms through the one or more straps such that a panel of the backpack contacts the user's back. In one aspect, the backpack is configured such that items stored in the main storage compartment are accessible by opening the closure system (e.g., releasable fasteners) securing any one or more of the panels to one another. Access may be allowed into the storage compartment from the top, bottom, left, or right side of the backpack, or any combination thereof, as opposed to limiting access from the top end of the backpack. Items stored within the accessory storage compartments are also accessible by opening any one or more of the fasteners or panels.

In a further aspect, the bag may be wearable as a duffle bag. For instance, the bag might include one or more straps that can be worn on one or both shoulders of a user. A first manner of wear for the bag may include the user placing one arm through the one or more straps such that a panel of the duffel bag contacts the user's side or front torso. A second manner of wear for the bag may include the user to placing one or both arms through the one or more straps such that a panel of the duffel bag contacts the user's back. In one aspect, the duffel bag is configured such that items stored in the main storage compartment are accessible by opening the closure system (e.g., releasable fasteners) securing any one or more of the panels to one another. Access may be allowed into the storage compartment from the top, bottom, left, or right side of the duffel bag, or any combination thereof, as opposed to limiting access from the top end of the duffel bag. Items stored within the accessory storage compartments are also accessible by opening any one or more of the fasteners or panels.

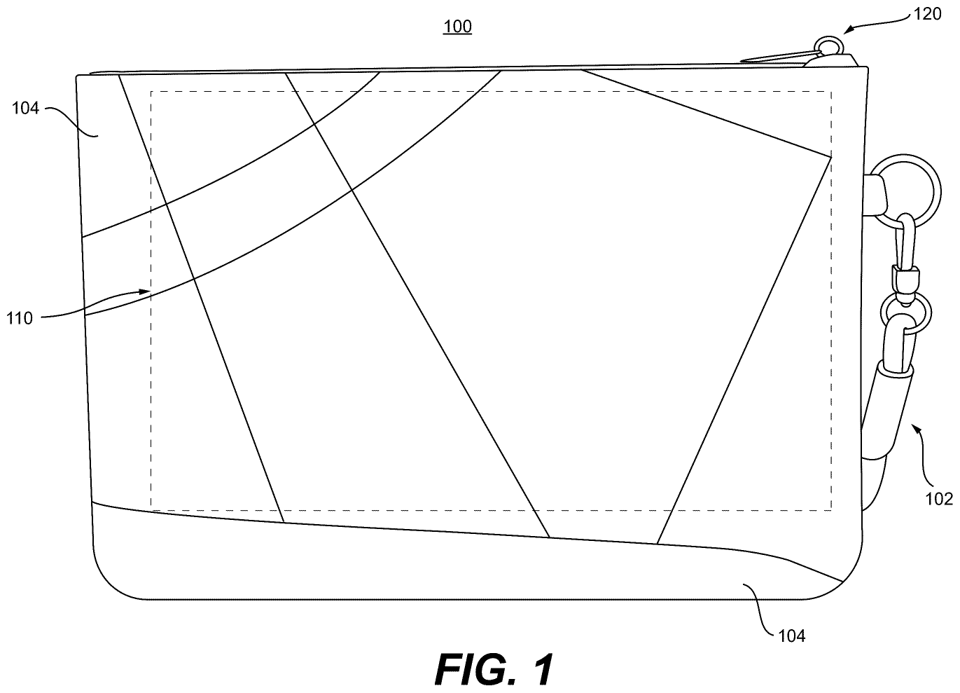

FIG. 1 depicts an exemplary portable bag 100 (hereinafter “bag”), according to one or more embodiments. Bag 100 may be a clutch, a wristlet, or a similarly sized bag worn on the wrist or carried by a user. Bag 100 is relatively small and compact in size, and may include a strap or a handle 102, making it easier to carry around. Bag 100 may include one or more storage compartments contained therein (not shown). Bag 100 may include one or more exterior surfaces 104 that make up the one or more storage compartments. The one or more exterior surfaces 104 may include at least a portion of an exterior surface 110 that is configured to transition between a first configuration and a second configuration. In one example, the first configuration may include an opaque coloration and the second configuration may include a transparent coloration. In other words, the bag 100 may be configured to transition from the first configuration in which the coloration of the portion of exterior surface 110 is substantially opaque, such that visibility through the portion of exterior surface 110 and into the interior volume of cavity of bag 100 is inhibited, towards the second configuration in which the coloration of the portion of exterior surface 110 is substantially transparent. In this instance, visibility through the portion of exterior surface 110 and into the interior volume or cavity of bag 100 is provided and/or allowed. Although a coloration of the portion of exterior surface 110 is described herein, it should be appreciated that other physical characteristics or material properties that may impact or influence the transparency of bag 100 may be selectively adjusted when transitioning between the configurations without departing from a scope of this disclosure.

The transition from the first configuration to the second configuration may be in response to an electrical signal received from a mobile device (not shown) that is communicatively coupled to bag 100. In this instance, a user may transmit the electrical signal from the mobile device to bag 100 when seeking to modify the configuration of the portion of exterior surface 110. Although only the portion of exterior surface 110 is shown and described herein as being adjustable, it should be appreciated that additional portions of bag 100 may be configured and operable to selectively change configurations without departing from a scope of this disclosure. Additionally and/or alternatively, in some examples, an entirety of bag 100 may be configured to change configurations such that all exterior surfaces 104 may be selectively modified between the opaque and transparent colorations. Bag 100 and the portion of the exterior surface 110 may be configured to transition from the second configuration to the first configuration in response to a duration exceeding a threshold time. For example, the threshold time may include a duration ranging from about 1 second to 10 minutes.

The one or more storage compartments of bag 100 may be defined by an interior volume or cavity of bag 100. The interior volume may include one or more walls (not shown). The one or more walls may include a first wall and a second wall, where the first and second walls are opposite one another and joined together at a first junction. The first junction may join the entirety of the first and second walls on at least three sides to create the interior volume of the bag 100. The bag 100 may include a closure system 120. For example, closure system 120 may include, but is not limited to, a zipper. Bag 100, although described to include first and second walls, may include fewer and/or additional walls to define the interior volume of the bag 100 without departing from a scope of this disclosure.

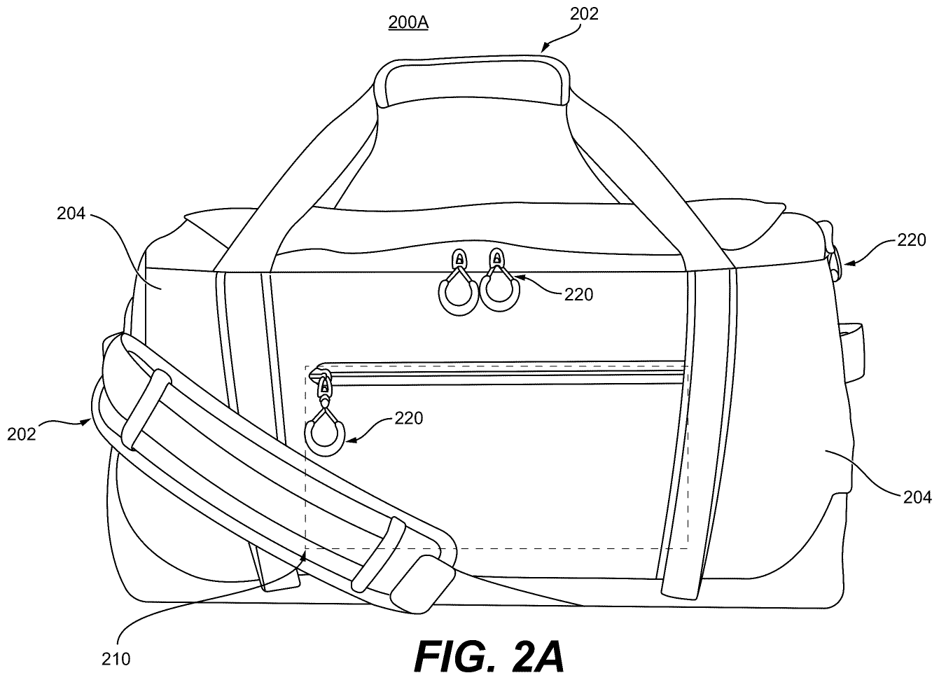

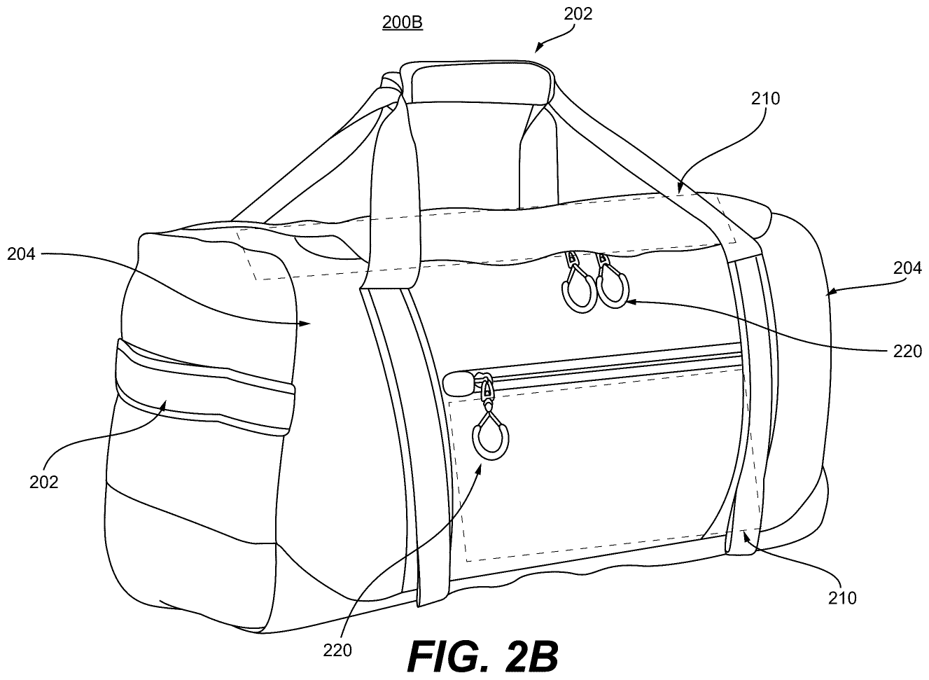

FIG. 2A depicts another exemplary portable bag 200A (hereinafter “bag”), according to one or more embodiments. Bag 200A may be a duffel bag or a similarly sized bag worn on the shoulder or back of a user. Bag 200A may include one or more straps or handles 202, making it easier to carry around. Bag 200A may include one or more storage compartments (not shown), such as one or more storage compartments positioned in the interior of bag 200A and one or more storage compartments positioned on the exterior of bag 200A. Bag 200A may include one or more exterior surfaces 204 that make up the one or more storage compartments. The one or more exterior surfaces 204 may include at least a portion of an exterior surface 210 that is configured to transition between a first configuration and a second configuration. In one example, the first configuration may include an opaque coloration and the second configuration may include a transparent coloration. In other words, the bag 200A may be configured to transition from the first configuration in which the coloration of the portion of exterior surface 210 is substantially opaque, such that visibility through the portion of exterior surface 210 and into the interior volume of cavity of bag 200A is inhibited, towards the second configuration in which the coloration of the portion of exterior surface 210 is substantially transparent. In this instance, visibility through the portion of exterior surface 210 and into the interior volume or cavity of bag 200A is provided and/or allowed.

The transition from the first configuration to the second configuration may be in response to a signal received from a mobile device (not shown) that is communicatively coupled to bag 200A. In this instance, a user may transmit the electrical signal from the mobile device to bag 200A when seeking to modify the configuration of the portion of exterior surface 210. Although only the portion of exterior surface 210 is shown and described herein as being adjustable, it should be appreciated that additional portions of bag 200A may be configured and operable to selectively change configurations without departing from a scope of this disclosure. Additionally and/or alternatively, in some examples, an entirety of bag 200A may be configured to change configurations such that all exterior surfaces 204 may be selectively modified between the opaque and transparent colorations. Bag 200A and the portion of the exterior surface 110 may be configured to transition from the second configuration to the first configuration in response to a duration exceeding a threshold time. For example, the threshold time may include a duration ranging from about 1 second to 10 minutes.

The one or more storage compartments of bag 200A may be defined by an interior volume or cavity of bag 200A. The interior volume may include one or more walls (not shown). The one or more walls may include a first wall, a second wall, a third wall, and a fourth wall. The first and second walls may be positioned opposite to one another, and the third and fourth walls may be positioned opposite to one another. The first and third walls may be positioned adjacent to one another and joined at a first junction. The first and fourth walls may be positioned adjacent to one another and joined at a second junction. The second and third walls may be positioned relatively adjacent to one another and joined at a third junction. The second and fourth walls may be positioned relatively adjacent to one another joined at a fourth junction. The first junction, second junction, third junction, and fourth junction may join to create the interior volume of the bag 200A. The bag 200A may include a closure system 220. For example, closure system 220 may include, but is not limited to, a zipper. Bag 200A, although described to include first, second, third, or fourth walls, may include fewer and/or additional walls to define the interior volume of the bag 200A without departing from a scope of this disclosure.

FIG. 2B depicts another exemplary portable bag 200B (herein after “bag”), according to one or more embodiments. Bag 200B may be similar to bag 200A, but for brevity similarities will not be repeated. Bag 200B may include one or more storage compartments contained therein (not shown). Bag 200B may include one or more exterior surfaces 204 that make up the one or more storage compartments. The one or more storage compartments may include exterior and interior storage compartments. The one or more exterior surfaces 204 may include at least a portion of the exterior surface 210 configured to transition between a first configuration and a second configuration. In one embodiment, the bag 200B may include multiple portions of the exterior surface 210 as shown. Each portion of the exterior surface 210 may be configured to transition between a first configuration and a second configuration independently from one another.

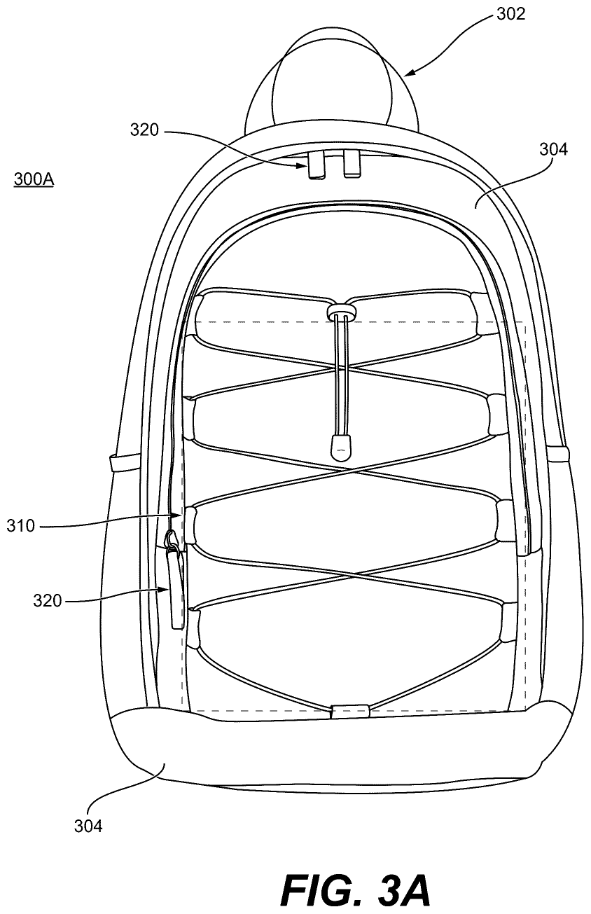

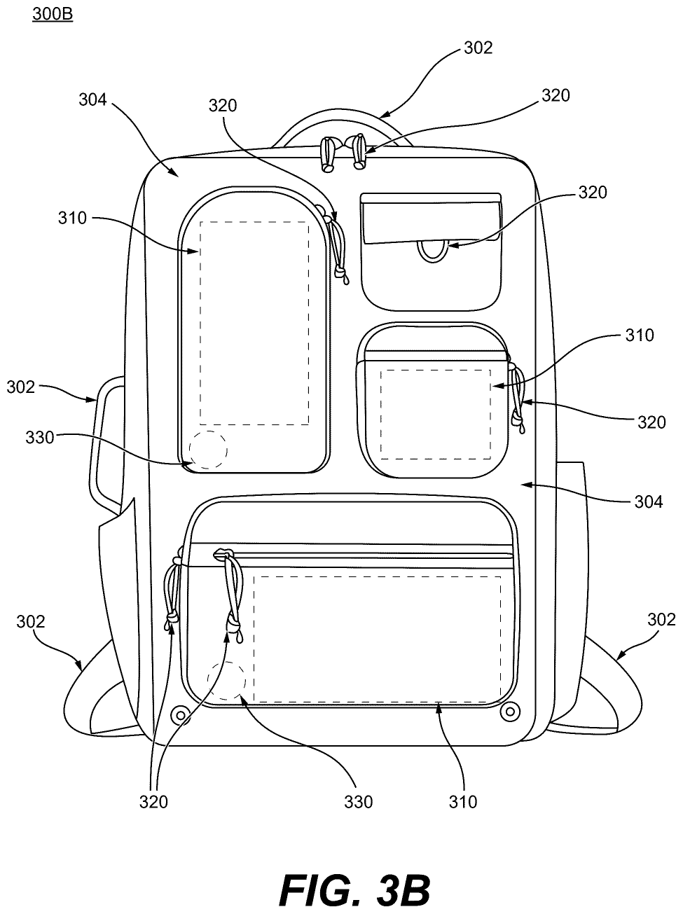

FIG. 3A depicts another exemplary portable bag 300A (hereinafter “bag”), according to one or more embodiments. Bag 300A may be a backpack or similar sized bag worn on the shoulder or back of a user. Bag 300A may include one or more straps or handles 302, making it easier to carry around. Bag 300A may include one or more storage compartments contained therein (not shown). Bag 300A may include one or more exterior surfaces 304 that make up the one or more storage compartments. The one or more exterior surfaces 304 may include at least a portion of the exterior surface 310 configured to transition between a first configuration and a second configuration. In one example, the first configuration may include an opaque coloration and the second configuration may include a transparent coloration. In other words, the bag 300A may be configured to transition from the first configuration in which the coloration of the portion of exterior surface 310 is substantially opaque, such that visibility through the portion of exterior surface 310 and into the interior volume of cavity of bag 300A is inhibited, towards the second configuration in which the coloration of the portion of exterior surface 310 is substantially transparent. In this instance, visibility through the portion of exterior surface 310 and into the interior volume or cavity of bag 300A is provided and/or allowed. Although a coloration of the portion of exterior surface 310 is described herein, it should be appreciated that other physical characteristics or material properties that may impact or influence the transparency of bag 300A may be selectively adjusted when transitioning between the configurations without departing from a scope of this disclosure.

The transition from the first configuration to the second configuration may be in response to an electrical signal received from a mobile device (not shown) that is communicatively coupled to bag 300A. In this instance, a user may transmit the electrical signal from the mobile device to bag 300A when seeking to modify the configuration of the portion of exterior surface 310. Although only the portion of exterior surface 310 is shown and described herein as being adjustable, it should be appreciated that additional portions of bag 300A may be configured and operable to selectively change configurations without departing from a scope of this disclosure. Additionally and/or alternatively, in some examples, an entirety of bag 300A may be configured to change configurations such that all exterior surfaces 304 may be selectively modified between the opaque and transparent colorations. Bag 300A and the portion of the exterior surface 310 may be configured to transition from the second configuration to the first configuration in response to a duration exceeding a threshold time. For example, the threshold time may include a duration ranging from about 1 second to 10 minutes.

The one or more storage compartments of bag 300A may be defined by an interior volume or cavity of bag 300A. The interior volume may include one or more walls (not shown). The one or more walls may include a first wall, a second wall, and a third wall. The first and second walls may be opposite one another. The third wall may be disposed between the first and second walls. The first and third walls may be adjacent to one another and joined at a first junction. The first and second walls may be adjacent to one another and joined at a second junction. The second and third walls may be adjacent to one another and joined at a third junction. The first junction, second junction, and third junction may join on at least three sides to create the interior volume of the bag 300A. The bag 300A may include a closure system 320. For example, closure system 320 may include, but is not limited to, a zipper. Bag 300A, although described to include first, second, and third walls, may include fewer and/or additional walls to define the interior volume of the bag 100 without departing from a scope of this disclosure.

FIG. 3B depicts another exemplary portable bag 300B (herein after “bag”), according to one or more embodiments. Bag 300B may be similar to bag 300A, but for brevity similarities will not be repeated. Bag 300B may include one or more storage compartments contained therein (not shown). Bag 300B may include one or more exterior surfaces 304 that make up the one or more storage compartments. The one or more storage compartments may include exterior and interior storage compartments. The one or more exterior surfaces 304 may include at least a portion of the exterior surface 310 configured to transition between a first configuration and a second configuration. In one embodiment, bag 300B may include multiple portions of the exterior surface 310 as shown. Each portion of the exterior surface 310 may be configured to transition between a first configuration and a second configuration independently from one another. Bag 300B may include one or more buttons 330. Each button 330 may be associated with one or more portions of the exterior surface 310. Button 330 may be configured to control the associated portion of the exterior surface 310 in transitioning between the first configuration and the second configuration. In one embodiment, the use of button 330 may be in place of the signal received from mobile device. In an alternative embodiment, button 330 may be used in conjunction with the received signal from the mobile device.

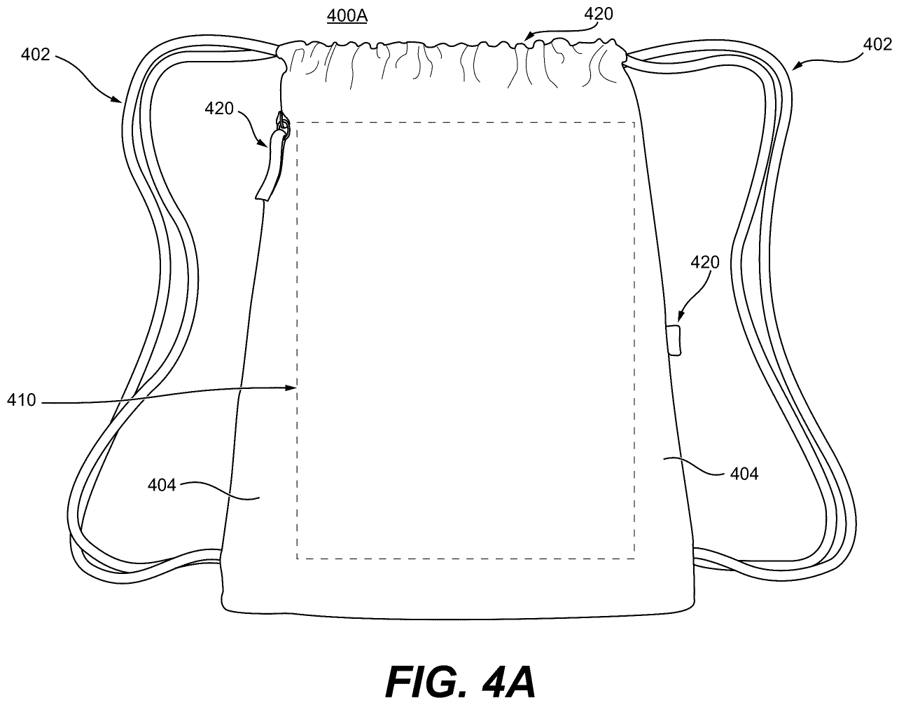

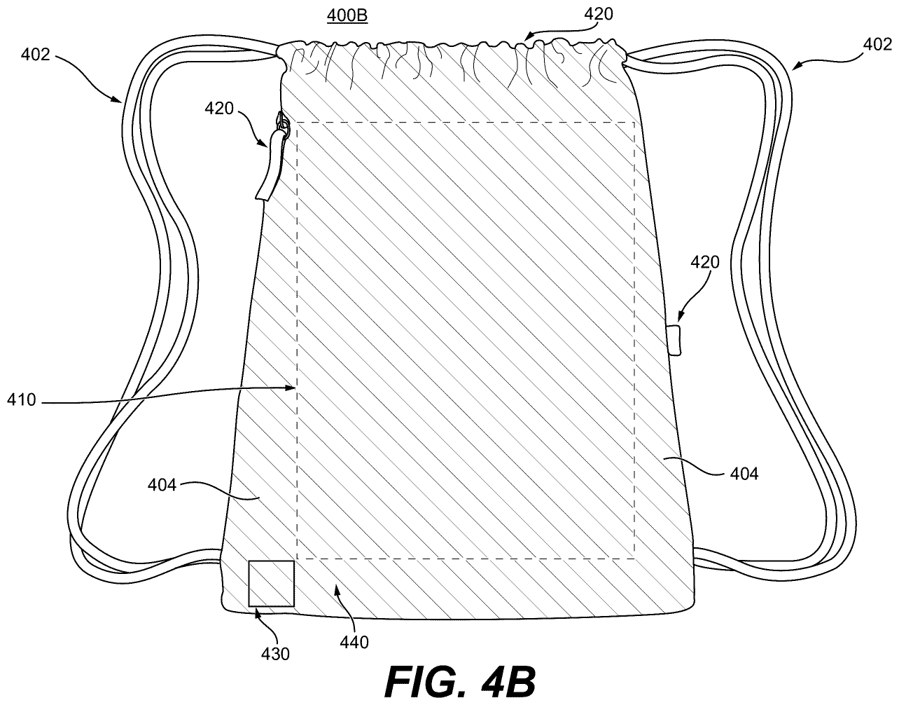

FIG. 4A depicts another exemplary portable bag 400A (hereinafter “bag”), according to one or more embodiments. Bag 400A may be a backpack or similar sized bag worn on the shoulder or back of a user. Bag 400A is relatively lightweight and may include one or more straps or handles 402, making it easier to carry around. Bag 100 may include one or more storage compartments contained therein (not shown). Bag 400A may include one or more exterior surfaces 404 that make up the one or more storage compartments. The one or more exterior surfaces 404 may include at least a portion of an exterior surface 410 that is configured to transition between a first configuration and a second configuration. In one example, the first configuration may include an opaque coloration and the second configuration may include a transparent coloration. In other words, the bag 400A may be configured to transition from the first configuration in which the coloration of the portion of exterior surface 410 is substantially opaque, such that visibility through the portion of exterior surface 410 and into the interior volume of cavity of bag 400A is inhibited, towards the second configuration in which the coloration of the portion of exterior surface 410 is substantially transparent. In this instance, visibility through the portion of exterior surface 410 and into the interior volume or cavity of bag 400A is provided and/or allowed. Although a coloration of the portion of exterior surface 410 is described herein, it should be appreciated that other physical characteristics or material properties that may impact or influence the transparency of bag 400A may be selectively adjusted when transitioning between the configurations without departing from a scope of this disclosure.

The transition from the first configuration to the second configuration may be in response to an electrical signal received from a mobile device (not shown) that is communicatively coupled to bag 400A. In this instance, a user may transmit the electrical signal from the mobile device to bag 400A when seeking to modify the configuration of the portion of exterior surface 410. Although only the portion of exterior surface 410 is shown and described herein as being adjustable, it should be appreciated that additional portions of bag 400A may be configured and operable to selectively change configurations without departing from a scope of this disclosure. Additionally and/or alternatively, in some examples, an entirety of bag 400A may be configured to change configurations such that all exterior surfaces 404 may be selectively modified between the opaque and transparent colorations. Bag 400A and the portion of the exterior surface 410 may be configured to transition from the second configuration to the first configuration in response to a duration exceeding a threshold time. For example, the threshold time may include a duration ranging from about 1 second to 10 minutes.

The one or more storage compartments of bag 400A may be defined by an interior volume or cavity of bag 400A. The interior volume may include one or more walls. The one or more walls may include a first wall and a second wall, where the first and second walls are opposite one another and joined at a first junction. The first junction may join the entirety of the first and second walls on at least three sides to create an interior volume of bag 400A. The interior volume may include a closure system 420. For example, closure system 420 may include, but is not limited to, a zipper. Bag 400A, although described to include first and second walls, may include fewer and/or additional walls to define the interior volume of the bag 400A without departing from a scope of this disclosure.

FIG. 4B depicts another exemplary portable bag 400A (hereinafter “bag”), according to one or more embodiments. Bag 400B may be similar to bag 400A, but for brevity similarities will not be repeated. Bag 400B may include coin slot 430. The coin slot 430 may be configured to store a power device (not shown) such as a battery. Bag 400B may be constructed of conductive yarn 440. The conductive yarn 440 may be configured to perform the function of power terminals for the power device. In one embodiment, the conductive yarn 440 may connect the coin slot 430 and the portion of the exterior surface 410. The power device within the coin slot 430 may provide power to the portion of the exterior surface 410 so as to transition from a first configuration to a second configuration.

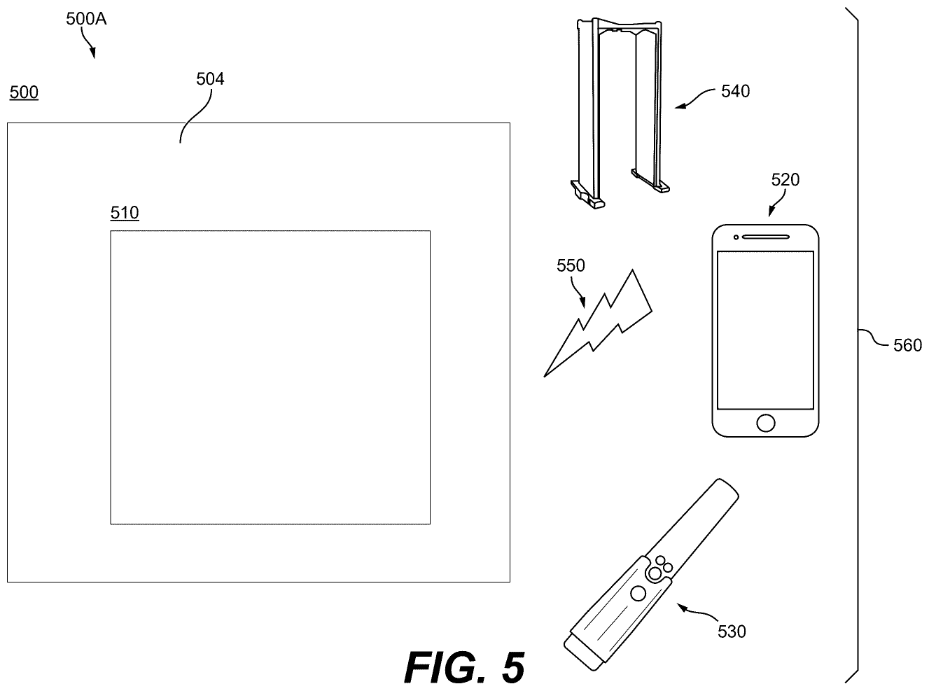

FIG. 5 depicts an exemplary system 500A for use with a portable bag 500 (hereinafter “bag”), according to one or more embodiments. System 500A may include bag 500, a wireless connection 550, and one or more mobile devices 560. It should be understood that bag 500 may include any one of bag 100, bag 200A, bag 200B, bag 300A, bag 300B, bag 400A, or bag 400B described above. Bag 500 may include a circuitry 510 that is disposed within one or more of exterior surfaces 504 of bag 500, as described in FIGS. 1-4. Circuitry 510 may be configured to transition at least a portion of an exterior surface 504 of bag 500, such as the portions of exterior surface 110, 210, 310, 410 of bags 100, 200A, 200B, 300A, 300B, 400A, 400B, respectively, from a first configuration to a second configuration. In one example, the first configuration may include an opaque coloration and the second configuration may include a transparent coloration. In other words, the bag 500 may be configured to transition from the first configuration in which the coloration of the portion of exterior surface 504 is substantially opaque, such that visibility through the portion of exterior surface 504 and into the interior volume of cavity of bag 500 is inhibited, towards the second configuration in which the coloration of the portion of exterior surface 504 is substantially transparent. In this instance, visibility through the portion of exterior surface 504 and into the interior volume or cavity of bag 500 is provided and/or allowed. Although a coloration of the portion of exterior surface 504 is described herein, it should be appreciated that other physical characteristics or material properties that may impact or influence the transparency of bag 500 may be selectively adjusted when transitioning between the configurations without departing from a scope of this disclosure.

The transition from a first configuration to a second configuration may be in response to a signal received from a mobile device 560 via wireless connection 550 that is communicatively coupled to bag 500. In this instance, a user may transmit the electrical signal from the mobile device to bag 500 when seeking to modify the configuration of the portion of exterior surface 504. Although only the portion of exterior surface 504 is shown and described herein as being adjustable, it should be appreciated that additional portions of bag 500 may be configured and operable to selectively change configurations without departing from a scope of this disclosure. Additionally and/or alternatively, in some examples, an entirety of bag 500 may be configured to change configurations such that all portions of exterior surface 504 may be selectively modified between the opaque and transparent colorations. Bag 500 and the portion of the exterior surface 504 may be configured to transition from the second configuration to the first configuration in response to a duration exceeding a threshold time. For example, the threshold time may include a duration ranging from about 1 second to 10 minutes.

Wireless connection 550 may include one or more short range communications, such as at least one of a near-field-communication (NFC), Wi-Fi, Bluetooth, near-link, infrared (IR), radio frequency (RF), or various other suitable short range communications. For example, NFC is a wireless technology that enables communication between two electronic devices over a distance, such as but not limited to, a distance of about 4 cm (about 1.57 in) or less. NFC provides a low-speed connection through a setup that can be used to bootstrap more capable wireless connections. NFC is based on radio-frequency identification (RFID) standards, such as ISO/IEC 14443 and FeliCa, and may use the 13.56 MHz frequency band to transmit data and voice signals at data rates ranging from about 106 to about 848 kilobits per second (kbit/s). NFC devices may also communicate in different modes, such as point-to-point, broadcast, and mesh, depending on their roles and capabilities. NFC devices may be compatible with the Internet Protocol (IP). NFC may be configured in various applications using different domains, such as contactless transactions, data exchange, and simplified setup of more complex communications, such as Wi-Fi. NFC may provide high-precision location tracking. Wireless connection 550 may be configured to send data and/or power to a corresponding receiving antenna, such as, for example, a receiving antenna of circuitry 510. Wireless connection 550 may be configured to send and receive signals when one or more mobile devices 560 are within a predetermine distance from one another. For example, the predetermined distance may be less than about 100 meters.

Mobile devices 560 may include at least one mobile phone 520, a portable security wand 530, and/or a walk-through metal detector 540. Mobile devices 560 also may include, but is not limited to, a desktop computer, a workstation, a laptop computer, a tablet, a mobile handset, a personal digital assistant (PDA), a cellular telephone, a network appliance, a camera, a smart phone, a smart watch, an enhanced general packet radio service (EGPRS) mobile phone, a media player, a navigation device, a game console, a transportation security administration (TSA) conveyor belt, or any combination of these or other types of computing devices. Mobile devices 560 may be configured to communicate with one another by any suitable wired or wireless means (e.g., via Wi-Fi, radio frequency (RF), infrared (IR), Bluetooth, near-field-communication (NFC), or any other suitable means) to send and receive information.

Mobile devices 560 may include a display to present information to a user. The display may include one or more graphical user interfaces (GUI) for displaying information, and the displays may be configured to receive inputs from a user. Mobile devices 560 may include web or mobile applications (e.g., software applications) configured to control the operability of the portion of the exterior surface 504 and the circuitry 510 of bag 500. The application may include a home page displaying one or more interface objects and/or elements. The one or more interface objects or elements may be configured to receive user inputs, display and modify the status information for each of the portions of the exterior surface that are selectively adjustable, navigate between the one or more portions of the exterior surfaces, and alter an opacity value or coloration. In other words, bag 500 may include more than one portion of the exterior surface that is configured to transition from a first configuration to a second configuration. Each of portion of the exterior surface configured to transition from a first configuration to a second configuration may be associated with the one or more interface objects or elements. A user may interact with the one or more interface objects and/or elements through the display of mobile device(s) 560, where the display may include at least one of a touch screen, touchpad, keypad, mouse, keyboard, or any other suitable user input means. A user may navigate within the home page of the application to make selections of each portion of the exterior surface 504 of bag 500 with corresponding circuitry 510. Each interface object and/or element may display the current status information of the corresponding portion of the exterior surface 504 in communication with circuitry 510. A user may select at least one of the interface object and/or elements to change the status (e.g., activate, alter an opacity value, etc.) of the portion of the exterior surface 504 and/or view additional information for that particular portion of the exterior surface 504. In the latter, the additional information may be presented to change one or more of opacity and/or transparency values, and timing and/or duration thresholds associated with each of the first and second configurations.

For example, a user of mobile phone 520 may wish to transition the portion of the exterior surface 504 from a first configuration to a second configuration to view the contents of the bag 500. In doing so, creates an efficient way to view the contents of the bag 500 without the need to open the bag 500. Alternatively, the user may wish to transition the portion of the exterior surface 504 from a second configuration to a first configuration when the user wants to keep the contents of the bag 500 out of view from other users, for instance in public spaces. The use of mobile phone 520 allows the user to transition the portion of the exterior surface 504 from a first configuration to a second configuration or vice versa at their discretion.

In another example, a portable security wand 530 may be used to transition a portion of the exterior surface 504 of bag 500 from a first configuration to a second configuration to security purposes. A user of portable security wand 530 may be stationed at an entrance of a venue where each additional user entering the venue may be required to open their purse or bag for security purposes. The user of portable security wand 530 may bring the portable security wand 530 into close proximity to the bag 500 and transition a portion of the exterior surface 504 of the bag 500 from a first configuration to a second configuration. Transitioning the portion of the exterior surface 504 from a first configuration to a second configuration may allow the user of the portable security wand 530 to view the contents of the bag 500 without the need to physically open and search the bag 500 by hand. The bag 500 may then transition from a second configuration to a first configuration after a threshold time, shielding the contents of the bag 500 from view of others.

In a further example, a walk-through metal detector 540 may be used at security checkpoints, for instance at an airport or public venue. The walk-through metal detector 540, upon a user carrying a bag 500 entering the walk-through metal detector 540, may transition a portion of the exterior surface 504 of the bag 500 from a first configuration to a second configuration. Transitioning the portion of the exterior surface 504 from a first configuration to a second configuration may allow a user operating the walk-through metal detector 540 to view the contents of the bag 500 without the need to physically open and search the bag 500 by hand. The bag 500 may then transition from a second configuration to a first configuration after a threshold time, shielding the contents of the bag 500 from view of others.

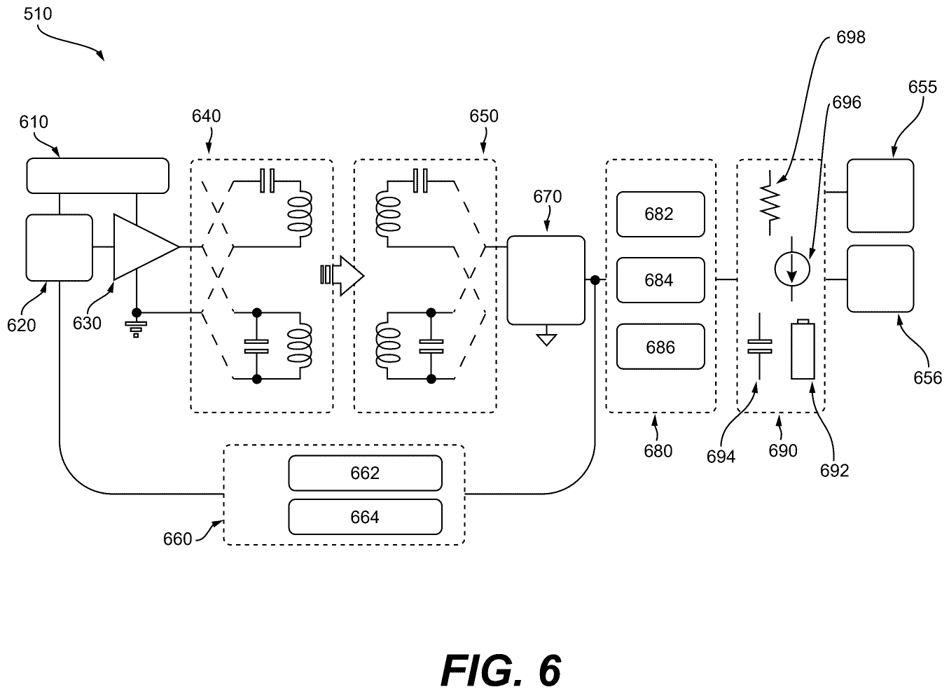

FIG. 6 depicts another exemplary circuit for use with a portable bag, such as circuitry 510 of bag 500 shown and described in detail above, according to one or more embodiments. Circuitry 510 may include a direct-current to direct-current (DC-DC) converter 610, a power control unit 620, a power amplifier (PA) 630, a transceiver resonator 640 (e.g., a first antenna), a receiver resonator 650 (e.g., a second antenna), a data link 660, a rectifier 670, one or more regulators 680, and one or more loads 690. Transceiver resonator 640 and receiver resonator 650 may be collectively configured to send and receive data and/or power between one another using short range communication, such as wireless connection 550 described above. Power amplifier 630 may be configured to receive power from transceiver resonator 640. DC-DC converter 610 may be configured to convert the received power from power amplifier 630. For example, DC-DC converter 610 may be an electronic circuit or electromechanical device that may be configured to convert a source of direct current (DC) (e.g., power) from one voltage to another voltage. Power control unit 620 may be configured to convert battery power to power circuitry 510 of bag 500.

Receiver resonator 650 may be configured to send and receive data and/or power between transceiver resonator 640. Receiver resonator 650 may be further configured to send the received data and/or power to rectifier 670. Rectifier 670 may be configured to amplify the power received from receiver resonator 650. The power amplified by rectifier 670 may be directed to regulators 680, loads 690, button 655, and/or global positioning system (GPS) devices 656 for use and/or storage. Regulators 680 may include a series regulator 682, a shunt regulator 684, a DC-DC converter 686, or any other suitable devices. Loads 690 may include one or more batteries 692, capacitors 694, transistors 696, resistors 698, or any other suitable devices. Batteries 692 may include any suitable batteries including rechargeable batteries. Rectifier 670 may further be configured to send the amplified data and/or power to data link 660. Data link 660 may include a load modulation 662 and an RF communication 664. Data link 660 may be configured to send the data and/or power received from rectifier 670 to power control unit 620.

In one embodiment, the button 655 may be the same as the button 330 referenced in FIG. 3B. The button 655 may be associated with circuitry 510 that is disposed within one or more of exterior surfaces 504 of bag 500. Button 655 may be configured to control the associated circuitry 510 in transitioning between the first configuration and the second configuration. In one embodiment, the use of button 655 may be in place of the signal received from mobile devices 560. In another embodiment, button 655 may be used in conjunction with the received signal from the mobile devices 560. In a further embodiment, the button 655 may be configured to enter and exit privacy mode. Privacy mode, when activated, may be configured to reject incoming signals from mobile devices. This would allow the bag 500 to maintain the first configuration even in the presence of incoming signals from mobile devices 560.

In one embodiment, GPS device 656 may be configured to determine a location of the bag 500. In determining the location of the bag 500, the GPS device 656 may be configured to determine a zone or area of interest that may require the portion of the exterior surface 504 to transition from the first configuration to the second configuration. For example, some schools may require the use of a transparent bag while on school property. The bag 500 and the associated GPS device 656 may be given location information (e.g., GPS coordinates) of a zone or area of interest (e.g., school campus). When the bag 500 is determined to be within the zone or area of interest the bag 500 may transition from the first configuration to the second configuration. The second configuration may be maintained while the bag 500 is within the zone or area of interest. For the bag 500 to maintain the second configuration, a battery or power source (e.g., battery 692), may be configured to power the circuitry 510 and the portion of the exterior surface 504 for an extended duration. Upon leaving the zone or area of interest, the bag 500 may be configured to transition from the second configuration to the first configuration. The battery or power source (e.g., battery 692) may need to recharge. The circuitry 510 may include a charging port (not shown) configured to recharge the batteries 692. In an alternative embodiment, the bag 500 may include a coin slot 430 as referenced in FIG. 4B.

One or more embodiments may include some or all of the components of circuitry 510 described herein. Some or all of the components described may be incorporated within circuitry 510 of bag 500, while other components may be incorporated into one or more mobile devices 560.

In one or more embodiments, bag 500 may include a battery (not shown) built into at least one exterior surface 504. For example, the battery may be built into at least a portion of the exterior surface 504 of bag 500, such that circuitry 510 may be configured to exclude the battery from loads 690. In this instance, circuitry 510 may be configured to send and/or receive only data transmission, thereby utilizing short range communications that do not send power.

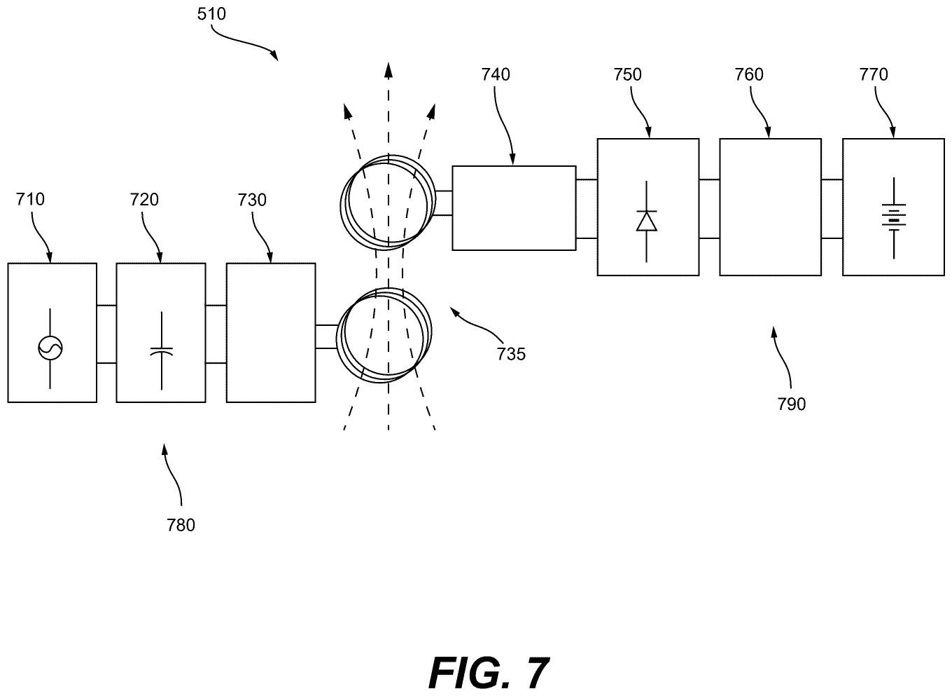

FIG. 7 depicts another exemplary circuit for use with a portable bag, such as circuitry 510 of bag 500 shown and described in detail above, according to one or more embodiments. Circuitry 510 may be configured as a receiver 790. Receiver 790 may include a compensation network 740, a rectifier 750, a DC-DC converter 760, and a battery 770. Compensation network 740 (e.g., an antenna) may be configured to send and receive data and/or power from a transmitter 780. Compensation network 740 may be configured to transmit the data and/or power received from transmitter 780 to rectifier 750. Rectifier 750 may be configured to amplify the received data and/or power. DC-DC converter 760 may be configured to convert the received and amplified power in rectifier 750 from one voltage to another. DC-DC converter 760 may be further configured to transmit the converted power to battery 770. Battery 770 may be configured to store and use power received within circuitry 510.

Transmitter 780 may be part of and/or integrated in mobile device 560 (see FIG. 6). Transmitter 780 may include an impedance matching network 730, an electromagnetic compatibility (EMC) filter 720, and a supply 710. Impedance matching network 730 may be configured to send and receive data and/or power. The data and/or power may be sent and received by either impedance matching network 730 and/or compensation network 740. EMC filter 720 may be configured to ensure that electrical and electronic equipment (e.g., transmitter 780 and/or receiver 790) function properly within the same electromagnetic environment without interfering with one another. Supply 710 may be configured to supply power to EMC filter 720 and impedance matching network 730 for sending and receiving data and/or power 735.

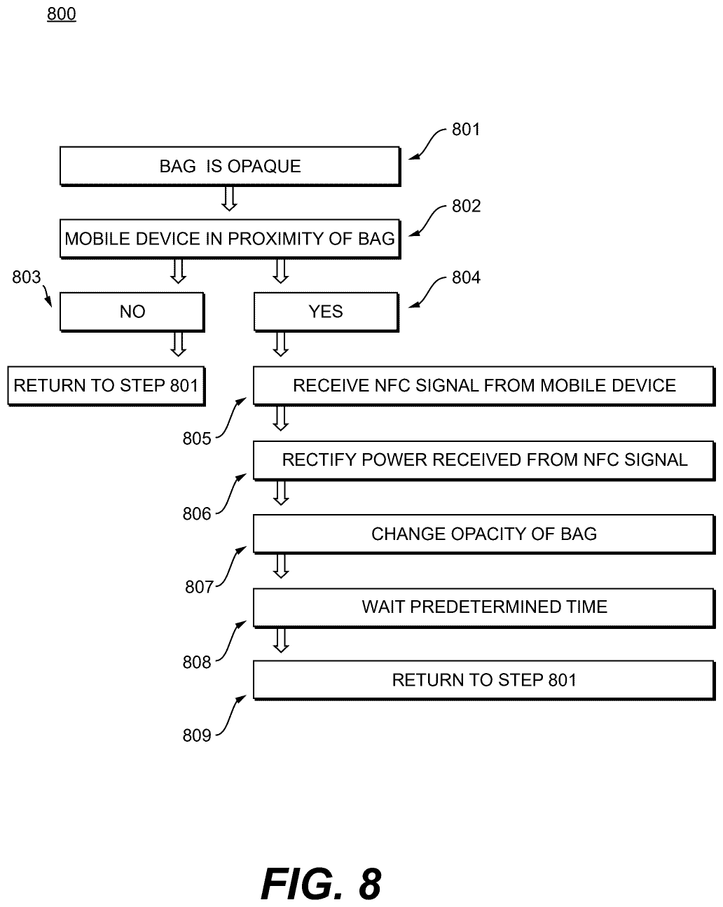

FIG. 8 depicts a flow diagram of an exemplary method 800 for using a portable bag, such as bag 500, according to one or more embodiments. Method 800 may cause a change in a visual configuration of a portions of the exterior surface 504 of bag 500. Method 800 may start at step 801 where the portion of the exterior surface 504 of bag 500 is in a first configuration, where the first configuration is an opaque coloration. At step 802, circuitry 510 may be configured to determine whether one or more mobile devices 560 (e.g., mobile phone 520, portable security wand 530, walk-through metal detector 540, etc.) is in proximity to bag 500 by a predetermined threshold distance (e.g., ranging from about 4 centimeters to about 100 meters). For example, circuitry 510 may be configured to determine a relative location of mobile device(s) 560 to bag 500 via the one or more antennas (e.g., transceiver resonator 640, receiver resonator 650, impedance matching network 730, or compensation network 740) included within each of bag 500 and mobile device(s) 560, respectively.

If it is determined by circuitry 510 in step 802 that bag 500 and at least one mobile device 560 is not within the predetermined threshold distance at step 803, circuitry 510 may be configured to return to step 801. If it is determined by circuitry 510 in step 802 that bag 500 and at least one mobile device 560 is within the predetermined threshold distance (e.g., about 20 centimeters) at step 804, circuitry 510 may be configured to proceed to step 805. Optionally, when privacy mode is activated, a determination of “yes” at step 804 the method 800 may return to step 801. At step 805, circuitry 510 may be configured to receive a signal (e.g., NFC) from mobile device 560. The received signal may be received by circuitry 510 as described above in FIGS. 5-7. Circuitry 510 may be configured to, at step 806, rectify the data and/or power received from mobile device 560. After rectifying the data and/or power, in step 806, circuitry 510 at step 807 may be configured to transition the portion of the exterior surface 504 of bag 500 from a first configuration to a second configuration. The first configuration may be an opaque coloration and the second configuration may be a transparent coloration, as described in detail above.

Still referring to FIG. 8, the transition from the first configuration to the second configuration may take place over a first time period, where the first time period may be less than or equal to about 2 seconds. The first time period may also be selectively adjustable by the user of bag 500, such as via one or more user inputs from mobile device 560. Circuitry 510 may be configured to, at step 808, wait a predetermined time (e.g., about 10 seconds, or selectively adjustable by the user) maintaining the portion of the exterior surface 504 in the second configuration. Optionally, step 808 may be replaced by a similar step as described in step 802 of the method 800. For example, when the bag 500 is determined to be in proximity of the mobile device 560 the circuitry 510 may be configured to transition the portion of the exterior surface 504 of the bag 500 from a first configuration to a second configuration. When the bag 500 is determined not to be in proximity of the mobile device 560 the circuitry 510 may be configured to transition the portion of the exterior surface 504 of the bag 500 from the second configuration to the first configuration. In this example, the transition between configurations (e.g., first and second configurations) may only occur when the bag 500 is determined to be in proximity of the mobile device 560. Returning to step 808, when the predetermined time exceeds the threshold time described in detail above, circuitry 510 at step 809 may be configured to return to step 801 and transition the portion of the exterior surface 504 of bag 500 from the second configuration to the first configuration. The transition from the second configuration to the first configuration may take place over a second time period, where the second time period may be greater than or equal to about 2 seconds. The second time period may also be selectively adjustable by the user of bag 500, such as via one or more user inputs from mobile device 560.

A person having ordinary skill in the art may perform the method 800 as described above using some or all of the steps described in the same or similar order, or a rearranged order, depending on the application without departing from a scope of this disclosure.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

The following clauses provide an exemplary configuration for a bag described above.

Clause 1. A bag, comprising: an exterior surface; and a storage compartment defining an interior volume; wherein at least a portion of the exterior surface is configured to transition between a first configuration and a second configuration in response to the bag receiving a signal.

Clause 2. The bag of clause 1, wherein the first configuration is opaque such that the interior volume of the storage compartment is not visible through the portion of the exterior surface.

Clause 3. The bag of clause 1, wherein the second configuration is transparent such that the interior volume of the storage compartment is visible through the portion of the exterior surface.

Clause 4. The bag of clause 1, wherein the signal includes a voltage received by the bag wirelessly from a mobile device.

Clause 5. The bag of clause 4, wherein the mobile device includes at least one of: a mobile phone; a portable security wand; a tablet; a transportation security administration (TSA) conveyor belt; and a walk-through metal detector.

Clause 6. The bag of claim 1, wherein the signal includes at least one of: a near-field-communication (NFC) signal; a Wi-Fi signal; a Bluetooth signal; and a near-link signal.

Clause 7. The bag of clause 1, further includes: wherein the bag is configured to maintain the second configuration for a threshold time, wherein the threshold time is about 10 seconds.

Clause 8. The bag of clause 7, further includes: wherein the bag is configured to transition to the first configuration after the threshold time has been exceeded.

Clause 9. The bag of clause 1, further includes: at least one button, and wherein the received signal includes activation of the at least one button.

Clause 10. The bag of clause 1, further includes: two or more storage compartments each defining an interior volume, wherein the two or more storage compartments further include: at least a portion of the exterior surface is configured to transition between a first configuration and a second configuration in response to the bag receiving a signal.

Clause 11. A bag, comprising: an exterior surface; and a circuitry configured to: determine a proximity of the bag to a mobile device; receive a signal from the mobile device; and transition a portion of the exterior surface from a first configuration to a second configuration in response to receiving the signal.

Clause 12. The bag of clause 11, wherein the signal includes at least one of: a near-field-communication (NFC) signal; a Wi-Fi signal; a Bluetooth signal; and a near-link signal.

Clause 13. The bag of clause 11, wherein the mobile device includes at least one of: a mobile phone; a portable security wand; a tablet; a transportation security administration (TSA) conveyor belt; and a walk-through metal detector.

Clause 14. The bag of clause 11, wherein the signal includes a voltage.

Clause 15. The bag of clause 11, wherein the circuitry is configured to transition the portion of the exterior surface from the first configuration to the second configuration over a first time period and transition the portion of the exterior surface from the second configuration to the first configuration over a second time period.

Clause 16. The bag of clause 11, wherein the circuitry is configured to: transition the portion of the exterior surface from the second configuration to the first configuration after a threshold time.

Clause 17. A method for changing a visual configuration of a portion of an exterior surface of a bag, the method comprising: (A) determining a distance between a bag and a mobile device; (B) in response to the distance between the bag and the mobile device being greater than a threshold distance, maintaining the visual configuration of the portion of the exterior surface; (C) in response to the distance between the bag and the mobile device being less than or equal to the threshold distance, receiving a signal from the mobile device; (D) transitioning the visual configuration of the portion of the exterior surface from a first configuration to a second configuration; (E) maintaining the portion of the exterior surface in the second configuration for at least a predetermined time; and (F) determining the predetermined time exceeds a threshold time and transitioning the portion of the exterior surface from the second configuration to the first configuration.

Clause 18. The method of clause 17, wherein the threshold distance is about 20 centimeters and the threshold time is about 10 seconds.

Clause 19. The method of clause 17, wherein receiving the signal in step (C) comprises: amplifying the signal received from the mobile device to power the portion of the exterior surface.

Clause 20. The method of clause 17, wherein the mobile device includes a software application including: a home page with one or more elements associated with one or more portions of the exterior surface, wherein the one or more elements are selectable through the mobile device to activate the one or more portions of the exterior surface on the bag in response to transmitting the signal from the mobile device to the bag.

Clause 21. The method of clause 20, wherein the one or more elements in the software application is configured to display a status of each of the one or more portions of the exterior surface on the bag, the status indicating an opacity value associated with each portion of the exterior surface.

Clause 22. The method of clause 21, wherein the one or more elements in the software application is configured to allow a user to alter an opacity value of each portion of the exterior surface.

What is claimed is:

1. A bag, comprising:
an exterior surface; and
a storage compartment defining an interior volume;
wherein at least a portion of the exterior surface is configured to transition between a first configuration and a second configuration in response to the bag receiving a signal.

2. The bag of claim 1, wherein the first configuration is opaque such that the interior volume of the storage compartment is not visible through the portion of the exterior surface.

3. The bag of claim 1, wherein the second configuration is transparent such that the interior volume of the storage compartment is visible through the portion of the exterior surface.

4. The bag of claim 1, wherein the signal includes a voltage received by the bag wirelessly from a mobile device.

5. The bag of claim 4, wherein the mobile device includes at least one of:
a mobile phone;
a portable security wand;
a tablet;
a transportation security administration (TSA) conveyor belt; and
a walk-through metal detector.

6. The bag of claim 1, wherein the signal includes at least one of:
a near-field-communication (NFC) signal;
a Wi-Fi signal;
a Bluetooth signal; and
a near-link signal.

7. The bag of claim 1, further includes:
wherein the bag is configured to maintain the second configuration for a threshold time, wherein the threshold time is about 10 seconds, and
wherein the bag is configured to transition to the first configuration after the threshold time has been exceeded.

8. The bag of claim 1, further includes:
at least one button, and
wherein the received signal includes activation of the at least one button.

9. The bag of claim 1, further includes:
two or more storage compartments each defining an interior volume, wherein the two or more storage compartments further include:
at least a portion of the exterior surface is configured to transition between a first configuration and a second configuration in response to the bag receiving a signal.

10. A bag, comprising:
an exterior surface; and
a circuitry configured to:
determine a proximity of the bag to a mobile device;
receive a signal from the mobile device; and
transition a portion of the exterior surface from a first configuration to a second configuration in response to receiving the signal.

11. The bag of claim 10, wherein the signal includes at least one of:
a near-field-communication (NFC) signal;
a Wi-Fi signal;
a Bluetooth signal; and
a near-link signal.

12. The bag of claim 10, wherein the mobile device includes at least one of:
a mobile phone;
a portable security wand;
a tablet;
a transportation security administration (TSA) conveyor belt; and
a walk-through metal detector.

13. The bag of claim 10, wherein the signal includes a voltage.

14. The bag of claim 10, wherein the circuitry is configured to transition the portion of the exterior surface from the first configuration to the second configuration over a first time period and transition the portion of the exterior surface from the second configuration to the first configuration over a second time period; and
transition the portion of the exterior surface from the second configuration to the first configuration after a threshold time.

15. A method for changing a visual configuration of a portion of an exterior surface of a bag, the method comprising:
(A) determining a distance between a bag and a mobile device;
(B) in response to the distance between the bag and the mobile device being greater than a threshold distance, maintaining the visual configuration of the portion of the exterior surface;
(C) in response to the distance between the bag and the mobile device being less than or equal to the threshold distance, receiving a signal from the mobile device;
(D) transitioning the visual configuration of the portion of the exterior surface from a first configuration to a second configuration;
(E) maintaining the portion of the exterior surface in the second configuration for at least a predetermined time; and
(F) determining the predetermined time exceeds a threshold time and transitioning the portion of the exterior surface from the second configuration to the first configuration.

16. The method of claim 15, wherein the threshold distance is about 20 centimeters and the threshold time is about 10 seconds.

17. The method of claim 15, wherein receiving the signal in step (C) comprises:
amplifying the signal received from the mobile device to power the portion of the exterior surface.

18. The method of claim 15, wherein the mobile device includes a software application including:
a home page with one or more elements associated with one or more portions of the exterior surface, wherein the one or more elements are selectable through the mobile device to activate the one or more portions of the exterior surface on the bag in response to transmitting the signal from the mobile device to the bag.

19. The method of claim 15, wherein the one or more elements in the software application is configured to display a status of each of the one or more portions of the exterior surface on the bag, the status indicating an opacity value associated with each portion of the exterior surface.

20. The method of claim 19, wherein the one or more elements in the software application is configured to allow a user to alter an opacity value of each portion of the exterior surface.
